(19) United States
(12) Patent Application Publication
(10) Pub. No.: US 2022/0004190 A1
(43) Pub. Date: Jan. 6, 2022

(54) INFRASTRUCTURE SYSTEM

(71) Applicant: IMA Schelling Deutschland GmbH, Lübbecke (DE)

(72) Inventor: Stefan Rische, Bünde (DE)

(73) Assignee: IMA Schelling Deutschland GmbH, Lübbecke (DE)

(21) Appl. No.: 17/293,219

(22) PCT Filed: Nov. 29, 2019
(86) PCT No.: PCT/EP2019/083161

§ 371 Date: May 12, 2021

(30) Foreign Application Priority Data
Dec. 3, 2018 (DE) 10 2018 130 720.9

(51) Int. Cl. G05D 1/02

(52) U.S. Cl. CPC G05D 1/024; G05D 2201/0216; G05D 1/0214

(57) ABSTRACT

An infrastructure system with an automated guided vehicle system (FTS) that has an automated guided vehicle (AGV), and a control means. The infrastructure system has a safety region that has an entrance region through which the AGV can drive, wherein the AGV has a safety scanner which emits a scanning signal. The safety scanner is designed to detect objects and obstacles located in the driving region of the AGV independently of a navigation system for controlling and determining the position of the AGV. A sensor is arranged in the entrance region, which sensor can detect the scanning signal emitted by the AGV. The control means is designed, in response to a predefined scanning signal detected by the sensor, to determine the presence and/or authorization of the AGV in the entrance region, which authorization is required for driving into the safety region.

### CROSS REFERENCE TO RELATED APPLICATIONS

This patent application is the US national phase of and claims priority on and the benefit of International Application No. PCT/EP2019/083161 having an international filing date of 29 Nov. 2019, which claims priority on and the benefit of German Patent Application No. 10 2018 130 720.9 having a filing date of 3 Dec. 2018.

### BACKGROUND OF THE INVENTION

### Technical Field

The invention relates to an infrastructure system, comprising an automated guided vehicle system (FTS) that has at least one automated guided vehicle, and a control means, wherein the infrastructure system also comprises at least one safety region that has an entrance region through which the automated guided vehicle can drive.

### Prior Art

Infrastructure systems and methods for operating such infrastructure systems are known, for example, from DE 20 2015 001 193 A1, DE 20 2013 008 609 U1 and DE 697 12 906 T2. Automated guided vehicle systems are often used for automation in infrastructure systems of this type, which are also referred to in the following as infrastructures. They usually contain an infrastructure within which automated guided vehicles, also known as AGVs, move independently. These systems generally comprise a master control means that coordinates the corresponding AGVs. A navigation device is usually used for the vehicles so that they can move within the infrastructure in cooperation with the master control means. As corresponding automated guided vehicles drive through the infrastructure, there is always a chance that these vehicles might hit objects in the travel path or, for example, obstacles might appear. In addition to their actual navigation device, automated guided vehicles of this kind always also have a safety scanner which generally scans the region in front of the automated guided vehicle, i.e. the region which lies ahead in the direction of travel, for obstacles. These safety scanners can use different technologies. Inter alia, so-called laser scanners are known in which a laser beam having a particular scanning frequency is emitted by the scanner at an angle onto the floor in front of the automated guided vehicle. The laser beam is moved back and forth in order to scan not just one point in the space, but a region. If there is an obstacle in the way, the laser scanner which detects sensors or detection devices can detect laser light thrown back from an obstacle and correspondingly generate a signal that can instruct the vehicle to change direction or to stop if necessary. Of course, not only laser scanners can be used, but any type of transmitted signals such as ultrasound signals, general acoustic signals or electromagnetic signals are conceivable for this purpose.

In many infrastructures in which automated guided vehicles of this kind are on the move, there are also so-called safety regions, for example regions around machines which personnel can only enter under certain conditions, namely when appropriate safety can be guaranteed. The safety scenario when a person enters the safety region usually ensures that the machine located in the safety region can be stopped so that the person cannot be harmed. It is also conceivable that automated guided tools that are used in the corresponding infrastructure can come close to a safety region. Under certain circumstances, however, a risk that exists for a human person when entering the safety region does not exist or does not exist to the same extent for an automated guided vehicle that potentially delivers parts required for production, and therefore a different safety scenario can be run for such a case when an automated guided vehicle enters the safety region.

### BRIEF SUMMARY OF THE INVENTION

The problem addressed by the invention is that of providing an infrastructure system and a method for operating same by means of which it is possible to be able to run different safety scenarios in the safety region of an infrastructure.

This problem is solved by an infrastructure system comprising an automated guided vehicle system (FTS) that has at least one automated guided vehicle, and a control means, wherein the infrastructure system also comprises at least one safety region that has an entrance region through which the automated guided vehicle can drive, wherein the at least one automated guided vehicle has a safety scanner which emits a scanning signal and, independently of a navigation system for controlling and determining the position of the automated guided vehicle, detects objects and obstacles located in the driving region of the automated guided vehicle, wherein a sensor is arranged in the entrance region, which sensor can detect the scanning signal emitted by the at least one automated guided vehicle, wherein the control means, in response to a predefined scanning signal detected by the sensor, establishes the presence and/or authorization of the automated guided vehicle in the entrance region, which authorization is required for driving into the safety region, and a method for operating an infrastructure system, which method comprises providing an infrastructure system as disclosed herein, detecting a scanning signal of the at least one automated guided vehicle by means of the sensor, checking whether or not the detected scanning signal belongs to an automated guided vehicle which is in particular permitted to drive through a transit gate.

Advantageous embodiments can be found in the respective dependent claims.

The infrastructure system according to the invention comprises an automated guided vehicle system (FTS) that has at least one automated guided vehicle, a control means, and at least one safety region through which the automated guided vehicle can drive. The at least one automated guided vehicle has a safety scanner which emits a scanning signal. This safety scanner is designed to detect objects and obstacles located in the driving region of the automated guided vehicle independently of a navigation system for controlling and determining the position of the automated guided vehicle. According to the invention, a sensor is arranged in the entrance region, in particular a stationary part of the entrance region, which sensor can detect the scanning signal emitted by the at least one automated guided vehicle. The control means of the automated guided vehicle system is designed, in response to a predefined scanning signal detected by the sensor, to establish the presence and/or authorization of the automated guided vehicle in the entrance region, which authorization is required for driving into the safety region.

Objects and obstacles located in the driving region of the automated guided vehicle are thus detected by the safety scanner, independently of a navigation system for controlling and determining the position of the automated guided vehicle. The sensor located in the entrance region of the safety region is therefore able to recognize automated guided vehicles moving in the infrastructure when they approach the safety region. In this way, the control means of the automated guided vehicle system can be notified as to whether an automated guided vehicle, for example, is preparing to drive into the safety region. In this case in which the relevant guided vehicle is authorized to actually drive into the safety region, a corresponding safety scenario can be activated in the safety region for the control means. Therefore, in response to a predefined scanning signal detected by the sensor, the control means of the automated guided vehicle system establishes the presence and/or authorization of the automated guided vehicle in the entrance region, which authorization is required for driving into the safety region. If the automated guided vehicle detected by the sensor has authorization, an entrance gate for the safety region can also be opened for the automated guided vehicle, for example.

The scanning signal emitted by the safety scanner preferably comprises laser radiation, a radio signal and/or an acoustic signal. Depending on the design of the automated guided vehicle system, different safety scanners can be used. The sensors that are positioned at the entrance region to the safety region are designed accordingly such that they can recognize these scanning signals.

As already mentioned, for example, the entrance region can comprise a transit gate through which the automated guided vehicle can drive. The transit gate can, for example, have a door that can be opened by the control means in response to the established by the control means as being present and authorized. In the security region, the machine operated therein can continue to be operated in a possibly unchanged manner in this case, since it is ensured that no human personnel but instead only an autonomous vehicle enters the safety region. This helps to avoid machine downtime.

In order to detect objects that possibly do not only obstruct at certain points, in an advantageous embodiment the safety scanner of the automated guided vehicle has a scanner head that can be rotated at least in one plane. By pivoting the scanner head back and forth, a region in front of the automated guided vehicle is detected with regard to obstacles.

According to a particular embodiment of the present invention, the infrastructure comprises a machine workspace in which, for example, a woodworking machine or the like can be provided, the machine workspace being accessible via the entrance region, in particular the transit gate.

The safety scanner of the at least one automated guided vehicle preferably emits scanning signals which can in particular be laser radiation. The scanning signals are preferably emitted in pulses and/or at a predefined fixed or variable scanning frequency. The pulse frequency and/or the scanning frequency and/or the wavelength/energy of the emitted scanning signal can be set individually for each automated guided vehicle, so that a clear assignment of the automated guided vehicle is possible for the control means of the automated guided vehicle system and when detecting the automated guided vehicle by means of the sensor. In this way, for example, authorizations for the safety region for individual automated guided vehicles can be stored in the control means, which authorizations may or may not lead to the automated guided vehicle in question being released when a scanning signal is recognized by the sensor.

In the method according to the invention for operating an infrastructure system which has been described in particular above, the following steps are carried out according to the invention:
providing an infrastructure system as described above;
detecting a scanning signal, in particular laser radiation, of the at least one automated guided vehicle by means of the sensor,
checking whether or not the detected scanning signal belongs to an automated guided vehicle which is in particular permitted to drive through a transit gate.

According to an advantageous embodiment of the method according to the invention, the control means initiates the opening of a transit gate located in the entrance region to the safety region if the detected scanning signal belongs to an automated guided vehicle authorized to drive through, or, if the detected scanning signal does not belong to an authorized automated guided vehicle, the control means does not initiate the opening of the transit gate.

The check described above as to whether or not the detected scanning signal belongs to an automated guided vehicle authorized to drive through the transit gate can be carried out in different ways. This is preferably done by checking whether the scanning frequency of the scanning signal corresponds to a target value stored or predefined in the control means of the automated guided vehicle system and/or is within a predefined target value interval.

There are several ways of establishing whether an automated guided vehicle is approaching a safety region at the entrance region of which the sensor is attached. According to a preferred embodiment of the present invention, the distance of the automated guided vehicle from the entrance region of the safety region can be determined by measuring the pulse spacing of the scanning signal pulses emitted by the automated guided vehicle as a function of time. In this way, it can be established in a time-resolved manner whether a vehicle is approaching or moving away from the safety region. If the vehicle is authorized, a gate, for example, can hereby be opened before the entrance region is reached, so that the automated guided vehicle does not have to be stopped at all.

According to a preferred embodiment of the present invention, the distance between the automated guided vehicle and the safety region is determined from the height of the sensor above the floor and the beam angle of the detected scanning signal. Conversely, it is thus possible to set a particular minimum distance to the entrance region, within which distance the automated guided vehicle can move. This minimum distance is set at a constant beam angle of the safety scanner by fixing the sensor at a certain height as seen from the floor. The lower the sensor is fixed, i.e. the closer to the floor, the greater the minimum distance, i.e. the distance within which the automated guided vehicle can be detected by the sensor.

### BRIEF DESCRIPTION OF THE DRAWINGS

The invention will be explained in more detail in the following with reference to FIGS. 1 to 5.

FIG. 1 is a side view of an automated guided vehicle on a floor of an infrastructure system.

FIG. 2 is a plan view of the automated guided vehicle shown in FIG. 1.

FIG. 3 is a further side view of the automated guided vehicle in the region of the entrance region of an infrastructure system.

FIG. 4 is a plan view of the situation in FIG. 3.

FIG. 5 is another further side view in the region of the entrance region of an infrastructure system.

### DETAILED DESCRIPTION OF PREFERRED EMBODIMENTS

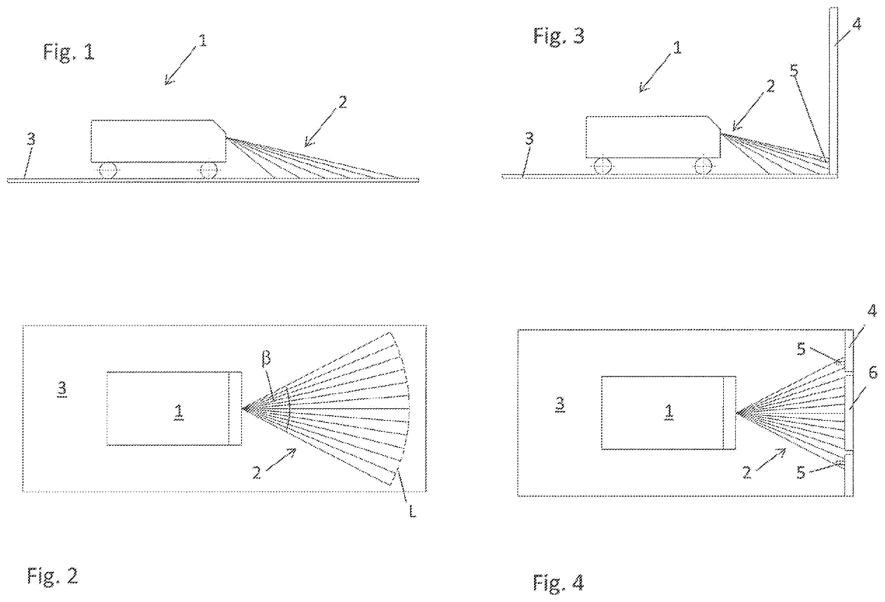

FIG. 1 is a schematic view of an AGV 1 which moves automatically on a floor 3. The AGV 1 is part of an automated guided vehicle system, which in turn is part of an infrastructure system, and has a suitable navigation device (not shown). In addition, the AGV 1 has a safety scanner that emits a scanning signal 2 into the region in front of the AGV. FIG. 2 shows that the scanning signal 2, which can be a laser beam or any other type of reflectable signal, is preferably emitted by the safety scanner into the space in front of the AGV 1 at an aperture angle β. If the scanning signal is a laser beam, for example, this beam is periodically moved back and forth as indicated by the line L. In so doing, the scanning signal 2 travels over a certain angle β in the space at a particular scanning frequency (this can be, for example, the number of back and forth movements of the scanning signal per unit of time). Objects that lie within the cone thus formed by the scanning beam reflect the scanning signal back to the safety scanner, where a corresponding reflex is then detected and it is thus established that an object is in the travel path of the automated guided vehicle system.

In the infrastructure system according to the invention, the scanning signal 2 is not only used to detect obstacles but is also used to identify an AGV 1 in or at a safety region of the infrastructure.

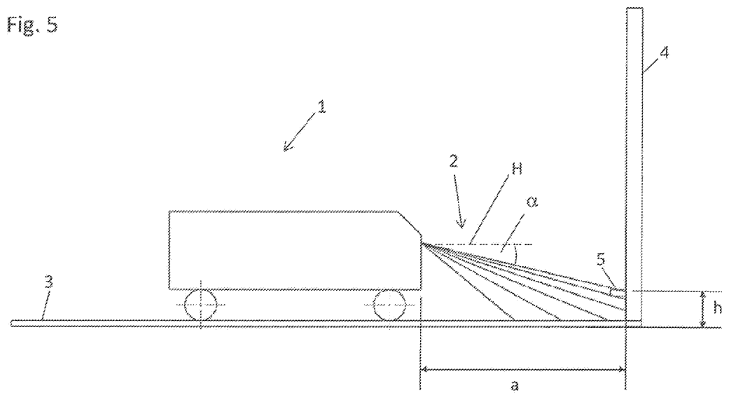

For this purpose, the safety region, as shown in FIGS. 3 and 4, has a sensor 5 or a plurality of such sensors 5. These sensors 5 are designed to detect a scanning signal 2 emitted by the AGV. The sensors 5 communicate with the control means of the safety region, so that the control means is informed when an AGV 1 approaches the safety region. By way of example, the entrance region of the safety region is shown in FIGS. 3 and 4 as a transit gate 4 comprising a door 6 to be opened. However, the entrance region does not have to have a door. In the event that an AGV 1 is approaching, the control means can check whether the AGV 1 is permitted to drive into the safety region. If this is the case, the door 6 can be opened automatically.

As shown in FIG. 5, a minimum distance a can be defined using the vertical height h of the sensor 5. This distance a results from the beam angle α with respect to the horizontal H, at which angle the scanning signal, for example the laser radiation, is emitted in the direction of the floor 3. Therefore, the higher the sensor 5 is mounted above the floor 3, the smaller the minimum distance a becomes. The height h can therefore be used to set the extent to which the AGV 1 can approach the safety region (represented here by the reference sign 4) without a specific safety scenario having to be triggered in the safety region.

1. An infrastructure system, comprising an automated guided vehicle system (FTS) that has at least one automated guided vehicle (1), and a control means, wherein the infrastructure system also comprises at least one safety region that has an entrance region (4, 6) through which the automated guided vehicle (1) can drive, wherein the at least one automated guided vehicle (1) has a safety scanner which emits a scanning signal and, independently of a navigation system for controlling and determining the position of the automated guided vehicle (1), detects objects and obstacles located in the driving region of the automated guided vehicle (1), wherein a sensor (5) is arranged in the entrance region (4, 6), which sensor can detect the scanning signal (2) emitted by the at least one automated guided vehicle (1), wherein the control means, in response to a predefined scanning signal detected by the sensor (5), establishes the presence and/or authorization of the automated guided vehicle (1) in the entrance region (4, 6), which authorization is required for driving into the safety region.

2. The infrastructure system according to claim 1, wherein the scanning signal emitted by the safety scanner comprises laser radiation, a radio signal and/or an acoustic signal.

3. The infrastructure system according to claim 1, wherein the entrance region comprises a transit gate through which the automated guided vehicle can drive, which gate has a door (6) which can be opened by the control means in response to a established by the control means as being present and authorized.

4. The infrastructure system according to claim 1, wherein the safety scanner of the automated guided vehicle (1) has a scanner head that can be rotated at least in one plane.

5. The infrastructure system according to claim 1, further comprising a machine workspace which is accessible via the entrance region, in particular the transit gate (4, 6).

6. The infrastructure system according to claim 1, wherein the safety scanner of the at least one automated guided vehicle (1) emits scanning signals at a predefined fixed or variable scanning frequency.

7. The infrastructure system according to claim 1, wherein the safety scanner of the at least one automated guided vehicle (1) emits scanning signals in pulses.

8. The infrastructure system according to claim 1, wherein the sensor (5) is arranged in a stationary part (4) of the entrance region.

9. A method for operating an infrastructure system, which method comprises the following steps:
providing an infrastructure system comprising an automated guided vehicle system (FTS) that has at least one automated guided vehicle (1), and a control means, wherein the infrastructure system also comprises at least one safety region that has an entrance region (4, 6) through which the automated guided vehicle (1) can drive, wherein the at least one automated guided vehicle (1) has a safety scanner which emits a scanning signal and, independently of a navigation system for controlling and determining the position of the automated guided vehicle (1), detects objects and obstacles located in the driving region of the automated guided vehicle (1), wherein a sensor (5) is arranged in the entrance region (4, 6), which sensor can detect the scanning signal (2) emitted by the at least one automated guided vehicle (1), wherein the control means, in response to a predefined scanning signal detected by the sensor (5), establishes the presence and/or authorization of the automated guided vehicle (1) in the entrance region (4, 6), which authorization is required for driving into the safety region;
detecting a scanning signal (2) of the at least one automated guided vehicle (1) by means of the sensor (5); and
checking whether or not the detected scanning signal (2) belongs to an automated guided vehicle (1) which is in particular permitted to drive through a transit gate (4, 6).

10. The method according to claim 9, wherein the control means initiates the opening of a transit gate (6, 4) located in the entrance region to the safety region if the detected scanning signal (2) belongs to an automated guided vehicle (1) authorized to drive through, or in that the control means does not initiate the opening of the transit gate (6, 4) if the detected scanning signal (2) does not belong to an authorized automated guided vehicle (1).

11. The method according to claim 10, wherein the check as to whether or not the detected scanning signal (2) belongs to an automated guided vehicle (1) authorized to drive through the transit gate (4, 6) is carried out by checking whether the scanning frequency of the scanning signal (2) corresponds to a target value stored or predefined in the control means of the automated guided vehicle system (FTS) and/or is within a predefined target value interval.

12. The method according to claim 9, wherein the distance of the automated guided vehicle (1) from the entrance region to the safety region is determined by measuring the pulse spacing of the scanning signal pulses emitted by the automated guided vehicle (1) as a function of time.

13. The method according to claim 9, wherein the distance (a) of the automated guided vehicle (1) from the safety region is determined from the height (h) of the sensor (5) above the floor (3) and the beam angle (α) of the detected scanning signal (2).

14. The method according to claim 9, wherein the scanning signal (2) is laser radiation.
